(19) United States
(12) Patent Application Publication
(10) Pub. No.: US 2011/0153137 A1
(43) Pub. Date: Jun. 23, 2011

(54) METHOD OF GENERATING SPATIAL MAP USING FREELY TRAVELLING ROBOT, METHOD OF CALCULATING OPTIMAL TRAVELLING PATH USING SPATIAL MAP, AND ROBOT CONTROL DEVICE PERFORMING THE SAME

(75) Inventor: Jeong-Nam YEOM, Hwasun-gun (KR)

(73) Assignee: Electronics and Telecommunications Research Institute, Daejeon (KR)

(21) Appl. No.: 12/963,153

(22) Filed: Dec. 8, 2010

(30) Foreign Application Priority Data
Dec. 18, 2009 (KR) 10-2009-0127075
Mar. 22, 2010 (KR) 10-2010-0025299

(51) Int. Cl. G05D 1/02

(52) U.S. Cl. 701/25; 701/23

(57) ABSTRACT

Provided is a method of generating a spatial map using a freely travelling robot. The method of generating the spatial map includes calculating a global coordinate of the robot based on a local coordinate of the robot that is outputted from each of a plurality of location coordinate systems arranged in a space, and estimating a location of each of the plurality of location coordinate systems in the space based on the calculated global coordinate of the robot to generate a spatial map based on the estimated location of each of the plurality of location coordinate systems.

### CROSS REFERENCE TO RELATED APPLICATIONS

This application claims priority to Korean Patent Application Nos. 10-2009-0127075 filed on Dec. 18, 2009 and 10-2010-0025299 filed on Mar. 22, 2010, the entire contents of which are herein incorporated by reference.

### BACKGROUND OF THE INVENTION

1. Field of the Invention

The present invention relates to a robot travelling control technology, and more particularly, to a method of generating a spatial map using a freely travelling robot, a method of calculating an optimal travelling path using the spatial map, and a robot control device performing the same.

2. Description of the Related Art

In general, a freely travelling robot refers to a robot that includes a power source and a sensor in a main body and thus may freely travel even when a signal or power is not supplied to the robot from an external source.

The freely travelling robot includes map information on a specific space. To freely move in the specific space, the freely travelling robot finds the current location and sets a travelling path to a destination. Then, the freely travelling robot moves to the destination while avoiding obstacles sensed by a sensor.

In order to move toward the destination, the known freely travelling robot finds the location based on the location of beacons installed along the travelling path, which can be known by the strength of a signal transmitted from the beacons.

That is, the known freely travelling robot is oriented to the destination based on the signals received from the beacons. Accordingly, the known freely travelling robot suffers has a problem in that it takes other paths even if there is a shorter path, causing unnecessary travel to the destination.

### SUMMARY OF THE INVENTION

The present invention has been made in an effort to provide a method of generating a spatial map using a freely traveling robot.

The present invention has been made in another effort to provide a method of calculating an optimal travelling path of the freely traveling robot using the generated spatial map.

The present invention has been made in still another effort to provide a robot control device for generating a spatial map and calculating an optimal travelling path.

An exemplary embodiment of the present invention provides a method of generating a map using a freely travelling robot, including: calculating a global coordinate of the robot based on a local coordinate of the robot that is outputted from each of a plurality of location coordinate systems arranged in a space; and estimating a location of each of the plurality of location coordinate systems in the space based on the calculated global coordinate of the robot and generating a spatial map based on the estimated location of each of the plurality of location coordinate systems.

Another exemplary embodiment of the present invention provides a method of calculating an optimal travelling path of a freely travelling robot, including: receiving destination information from the robot; receiving a local coordinate of the robot outputted from one location coordinate system among a plurality of location coordinate systems located in a space; and finding a current location of the robot from the local coordinate of the robot based on a spatial map and calculating the shortest travelling distance from the current location to a destination based on the destination information.

Still another exemplary embodiment of the present invention provides a robot control device including: a spatial map generating unit that generates a spatial map based on a global coordinate of a robot calculated from a local coordinate of the robot in a space; and a travelling path calculating unit that calculates and outputs an optimal travelling path to a destination corresponding to destination information transmitted from the robot based on the spatial map.

According to the exemplary embodiments of the present invention, a method of generating a spatial map using a freely travelling robot, a method of calculating an optimal travelling path using the spatial map, and a robot control device performing the same may generate a spatial map for a space using a robot and a control device without using a separate device and calculate an optimal travelling path of the robot using the generated spatial map.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a view schematically illustrating a construction of a map system including a robot control device according to an exemplary embodiment of the present invention;

FIG. 2 is a block diagram schematically illustrating the map system shown in FIG. 1;

FIGS. 3 and 4 are flow charts illustrating a method of generating a spatial map using a map system according to an exemplary embodiment of the present invention; and

FIG. 5 is a flowchart illustrating a method of calculating an optimal traveling path using a map system according to an exemplary embodiment of the present invention.

### DETAILED DESCRIPTION OF THE PREFERRED EMBODIMENTS

The accompanying drawings illustrating exemplary embodiments of the present invention and contents described in the accompanying drawings should be referenced in order to fully appreciate operational advantages of the present invention and objects achieved by the exemplary embodiments of the present invention.

Hereinafter, the present invention will be described in detail by describing exemplary embodiments of the present invention with reference to the accompanying drawings. Like elements refer to like reference numerals shown in the drawings.

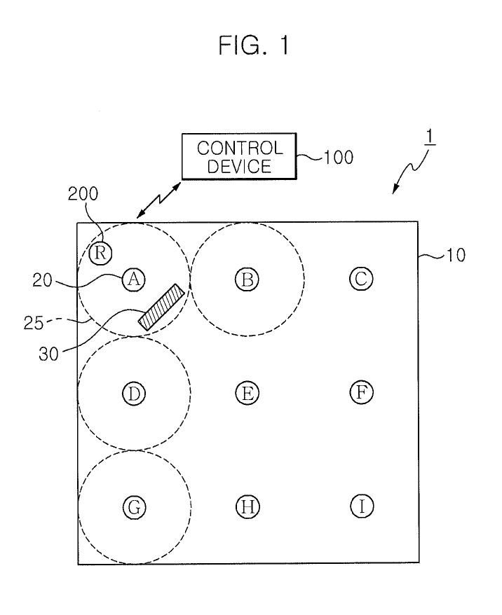

FIG. 1 is a view schematically illustrating a construction of a map system including a robot control device according to an exemplary embodiment of the present invention.

Referring to FIG. 1, the map system 1 may generate and manage a spatial map for a specific space 10 using a freely traveling robot (hereinafter, “robot”) 200 that travels (or moves) in the space 10.

Further, the map system 1 may calculate a traveling path to a predetermined destination along which the robot 200 travels in the space 10, that is, the optimal (shortest) traveling path to the destination, and control the robot 200 based on the traveling path.

The map system 1 may include the robot 200 and a robot control device 100. A plurality of location coordinate systems 20 and a plurality of obstacles 30 may be arranged in the space 10 in which the robot 200 travels. Here, the above-mentioned space 10 may be an indoor space of a certain area, such as a house or an office. Further, the plurality of location coordinate systems 20 may be arranged on a ceiling portion of the space 10 at predetermined intervals.

Each of the location coordinate systems 20 arranged in the space 10 may have a cell coverage 25 that covers a predetermined area of the space 10.

In other words, the bottom surface of the space 10, that is, the area in which the robot 200 actually travels, may be divided into a plurality of cells. Each location coordinate system 20 may detect whether or not the robot 200 is located in each cell.

When the robot 200 is located within the cell coverage area covered by one of the location coordinate systems 20, the one location coordinate system may output information on the location of the robot 200 in the cell coverage, that is, a local coordinate of the robot 200.

The robot 200 may be a freely traveling robot that may freely travel in the space 10, for example, such as a robot for cleaning or a robot for security.

The robot 200 may freely travel in the space 10 using various traveling methods including a wheel type traveling method in which the robot 200 moves by rotating a plurality of wheels of the robot using a servo motor or stepping motor, a caterpillar type traveling method in which the robot 200 moves using a caterpillar, or a joint type traveling method in which the robot 200 moves using a plurality of legs.

The robot control device 100 may receive various information, such as local coordinate information or destination information of the robot 200, from the robot 200 traveling in the space 10. The robot control device 100 may generate or manage a map for the space 10, i.e., a spatial map, or calculate an optimal traveling path of the robot 200 in the space 10 using the received information.

The robot control device 100 may include initial information on the space 10 (for example, size information of the space).

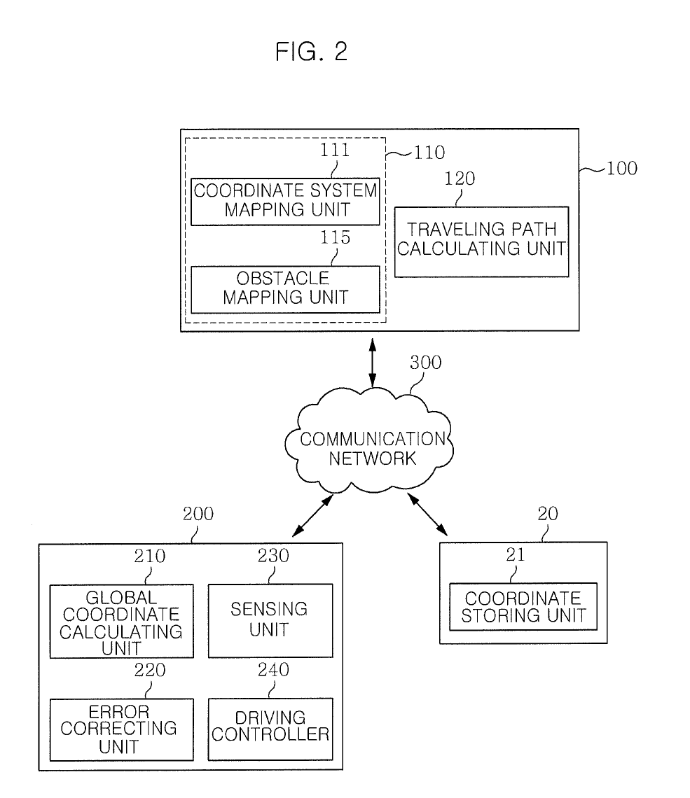

FIG. 2 is a block diagram schematically illustrating the map system shown in FIG. 1.

Referring to FIGS. 1 and 2, the robot 200, the robot control device 100, and the location coordinate system 20, which constitute the map system 1, may be connected to and communicate with one another over a communication network 300.

The communication network 300 may be, but not limited to, a local or remote wireless communication network.

The location coordinate system 20 may include a coordinate storing unit 21.

The coordinate storing unit 21 may store location information on a number of spots in the cell coverage 25 of the location coordinate system 20, that is, local coordinates for a plurality of spots defined with respect to the location coordinate system 20.

Accordingly, when detecting that the robot 200 is located in the cell coverage 25, the location coordinate system 20 may communicate with the robot 200 and, among the plurality of spots in the cell coverage 25, extract and output the local coordinate of the spot where the robot 200 is located.

The local coordinate of the robot 200 outputted from the location coordinate system 20 may be transmitted to the robot 200 or the robot control device 100 over the communication network 300.

An exemplary embodiment will be described with reference to FIG. 2, in which the local coordinate of the robot 200 outputted from the location coordinate system 20 is transmitted to the robot 200 through the communication network 300 and the location information of the robot 200 in the space 10 is calculated based on the local coordinate transmitted to the robot 200.

However, according to another exemplary embodiment, the local coordinate of the robot 200 outputted from the location coordinate system 20 may be transmitted to the robot control device 100 through the communication network 300 so that the robot control device 100 may calculate the location information of the robot 200 in the space 10 based on the transmitted local coordinate.

As mentioned above, the robot 200 may be a freely traveling robot, and may receive the local coordinate transmitted from the location coordinate system 20 while traveling in the space 10.

The robot 200 may include a global coordinate calculating unit 210, an error correcting unit 220, a sensing unit 230, and a driving controller 240.

The global coordinate calculating unit 210 may calculate the location information of the robot 200 in the space 10 based on the local coordinate of the robot 200 transmitted from the location coordinate system 20, for example, a global coordinate of the robot 200.

For example, the global coordinate calculating unit 210 may define as a central point of the space 10 the location coordinate system 20 having transmitted the local coordinate, and may calculate the global coordinate of the robot 200 in the space 10 using the local coordinate.

The calculated global coordinate may be transmitted to the robot control device 100 through the communication network 300.

The error correcting unit 220 may correct a calculation error occurring when the global coordinate calculating unit 210 calculates the global coordinate.

For example, the error correcting unit 220 may sense the number of rotations of the driving motor of the robot 200, i.e., servo motor. The robot 200 may generate an offset depending on the sensed number of rotations of the motor and correct the calculation error using the generated offset.

The sensing unit 230 may include various sensors, such as, for example, an ultrasonic sensor, a position sensitive device (PSD) sensor, or an imaging sensor, such as a CCD, or a CMOS.

The sensing unit 230 may sense the various obstacles 30 in the space 10 while the robot 200 travels in the space 10, and transmit a sensed result to the robot control device 100 through the communication network 300.

The robot control device 100 may analyze the sensed result on the obstacles 30 transmitted from the sensing unit 230 and, according to the analyzed result, may determine whether the obstacle 30 located in the space 10 is an obstacle fixed on a wall or furniture in the space 10, or a temporary obstacle located in the space 10, such as a human being, an animal, or a movable object.

Here, the robot 200 may transmit the location information of the spot where the obstacle 30 is detected as well as the sensed result outputted from the sensing unit 230 to the robot control device 100 as information on the obstacle.

The driving controller 240 may control the driving of the robot 200 so that the robot 200 may travel along the optimal traveling path in the space 10 based on a control signal transmitted from the robot control device 100.

For example, the robot 200 may transmit information on a destination to which the robot 200 moves in the space 10 to the robot control device 100 through the communication network 300.

The robot control device 100 may determine the current location of the robot 200 and the location of the destination based on the spatial map stored in the robot control device 100 and calculate the shortest traveling path based on a determined result. The calculated shortest traveling path may be outputted through the communication network 300 as a control signal controlling the operation of the robot 200.

The robot 200 may control the operation of a driving unit of the robot 200 to travel from the current location to the destination by the shortest path in response to the control signal transmitted from the robot control device 100.

The robot control device 100 may include a spatial map generating unit 110 and a traveling path calculating unit 120.

The spatial map generating unit 110 may generate a map for the space 10, i.e., the spatial map, using various information transmitted from the robot 200 through the communication network 300, such as, for example, the global coordinate information of the robot 200 or the obstacle information of the space 10.

The spatial map generating unit 110 may include a coordinate system mapping unit 111 and an obstacle mapping unit 115.

The coordinate system mapping unit 111 may estimate the coordinate of each of the plurality of location coordinate systems 20 arranged in the space 10 based on the global coordinate transmitted from the robot 200.

Also, the coordinate system mapping unit 111 may generate the spatial map by mapping the estimated coordinate of each of the plurality of location coordinate systems 20 to, for example, information on size or area of the predefined space 10.

The obstacle mapping unit 115 may estimate the coordinate of each of the plurality of obstacles 30 located in the space 10 from the obstacle information transmitted from the robot 200.

Also, the obstacle mapping unit 115 may map the estimated coordinate of each of the plurality of obstacles 30 to the space information.

In this case, if the coordinate system mapping unit 111 generates the spatial map by mapping the coordinate of one or more location coordinate system to the space information, the obstacle mapping unit 115 may update the spatial map by mapping the estimated coordinate of each of the plurality of obstacles 30 to the spatial map.

The traveling path calculating unit 120 may calculate the shortest traveling path of the robot 200 according to the destination information transmitted from the robot 200 based on the spatial map generated by the spatial map generating unit 110.

For example, the traveling path calculating unit 120 may determine the current location of the robot 200 and the location of the destination according to the destination information on the spatial map. The traveling path calculating unit 120 may calculate the shortest distance from the current location of the robot 200 to the destination based on a determined result and output the shortest traveling path having the calculated shortest distance.

Here, the traveling path calculating unit 120 may estimate several traveling paths from the current location of the robot 200 to the destination based on the spatial map and, among the several traveling paths, may select and output one path having the shortest traveling distance.

Further, the traveling path calculating unit 120 may generate a control signal including the calculated shortest path and output the control signal to the robot 200 through the communication network 300. The driving controller 240 of the robot 200 may control the driving unit in response to the transmitted control signal.

On the other hand, according to another exemplary embodiment, the shortest traveling path may also be calculated by the robot 200.

For example, the robot control device 100 may output the generated spatial map to the robot 200. The robot 200 may calculate paths to a preset destination based on the spatial map. Thereafter, the robot 200 may select a shortest path among the calculated paths and control the driving unit using the shortest path.

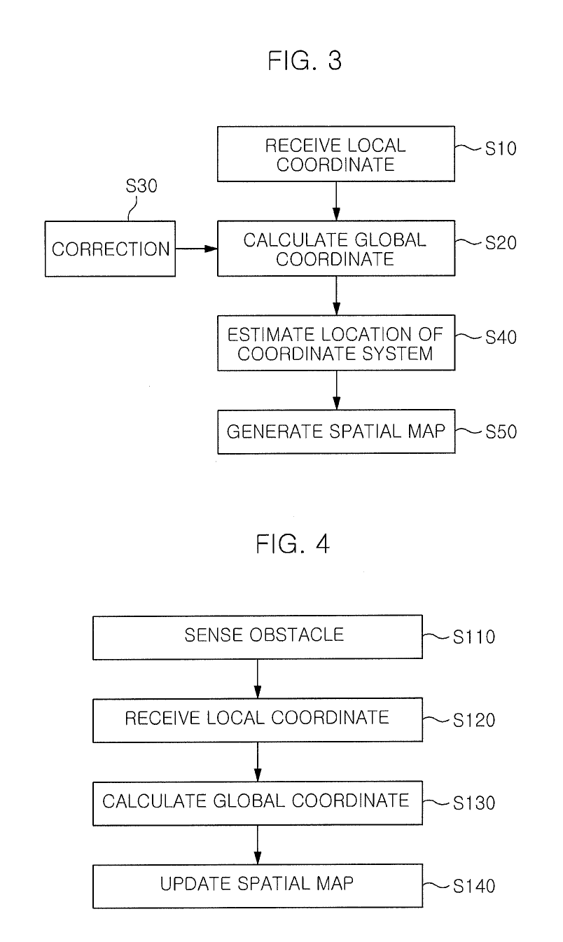

FIGS. 3 and 4 are flow charts illustrating a method of generating a spatial map using a map system according to an exemplary embodiment of the present invention.

Hereinafter, a method of generating a spatial map by the robot control device 100 based on a global coordinate transmitted from the robot 200 will be described with reference to the drawings.

Referring to FIGS. 1 to 3, the robot 200 may communicate with one of a plurality of location coordinate systems 20, for example, a first location coordinate system A, while freely traveling in the space 10.

The robot 200 may receive a local coordinate of the robot 200 from the first location coordinate system A (S10). Here, the local coordinate may be a relative location coordinate between the first location coordinate system A and the robot 200 in the cell coverage of the first location coordinate system A.

The global coordinate calculating unit 210 of the robot 200 may calculate a global coordinate of the robot 200 in the space 10 from the received local coordinate (S20).

For example, the robot 200 may receive space information from the robot control device 100. The global coordinate calculating unit 210 may define the first location coordinate system A as a central point of the space 10 based on the received space information. Subsequently, a relative location coordinate between the first location coordinate system A and the robot 200, that is, the global coordinate of the robot 200 may be calculated from the local coordinate. Here, the first location coordinate system A may be a location coordinate system that has for the first time transmitted a local coordinate to the robot 200.

On the other hand, the error correcting unit 220 of the robot 200 may detect the number of rotations of the driving motor of the robot 200 to generate an offset and correct the error when calculating the global coordinate using the generated offset (S30).

The calculated global coordinate may be transmitted to the robot control device 100. The robot control device 100 may estimate the coordinate of the first location coordinate system A in the space 10 from the global coordinate (S40).

Next, the robot control device 100 may generate a spatial map by mapping the estimate coordinate of the first location coordinate system A to the spatial map (S50).

In the meantime, the above-described steps, for example, the step of receiving the local coordinate by the robot 200, the step of calculating the global coordinate from the received local coordinate, and the step of transmitting the calculated global coordinate to the robot control device 100, may be repeatedly performed.

Accordingly, the robot control device 100 may update the spatial map by mapping the local coordinate of each of the remaining location coordinate systems transmitted from the robot 200 to the initially generated spatial map.

Hereinafter, a method of generating a spatial map by the robot control device 100 based on obstacle information transmitted from the robot 200 will be described with reference to the drawings.

Referring to FIGS. 1, 2, and 4, the robot 200 may sense one of a plurality of obstacles 30 while freely traveling in the space 10 (S110).

For example, the sensing unit 230 of the robot 200 that travels in the cell coverage of the first location coordinate system A may sense an obstacle in the cell coverage of the first location coordinate system A using various sensors.

Also, the robot 200 may receive a local coordinate for the location of the sensed obstacle from the first location coordinate system A (S120).

Further, the global coordinate calculating unit 210 of the robot 200 may calculate the global coordinate of the obstacle in the space 10 based on the received local coordinate, that is, the local coordinate for the location of the sensed obstacle (S130).

Here, the global coordinate calculating unit 210 may calculate the global coordinate of the obstacle in the same method as the above-described method for calculating the global coordinate of the robot 200.

That is, the robot 200 may calculate the global coordinate of the obstacle by using space information received from the robot control device 100. In this case, the robot 200 may also receive space information mapped with the coordinate of the first location coordinate system A, that is, the spatial map, from the robot control device 100.

The robot 200 may transmit the calculated global coordinate of the obstacle to the robot control device 100 through the communication network 300.

The robot control device 100 may estimate the location coordinate of the obstacle in the space 10 based on the transmitted global coordinate of the obstacle. Subsequently, the estimated location coordinate of the obstacle may be mapped to the space information or spatial map, and the spatial map may be updated (S140).

On the other hand, the above-described steps, for example, the step of calculating the global coordinate by the robot 200 sensing the obstacle and the step of transmitting the calculated global coordinate to the robot control device 100, may be repeatedly performed.

Accordingly, the robot control device 100 may update the spatial map by mapping the location coordinate of each of the remaining obstacles transmitted from the robot 200 to the generated spatial map.

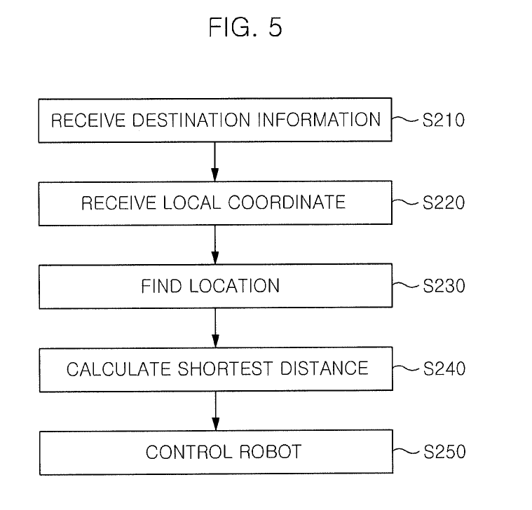

FIG. 5 is a flowchart illustrating a method of calculating an optimal traveling path using a map system according to an exemplary embodiment of the present invention.

Hereinafter, a method will be described with reference to the drawings, that calculates an optimal traveling path of the robot 200 based on a spatial map generated by the spatial map generating unit 110 of the robot control device 100 mapping each of a plurality of various location coordinate systems 20 with each of a plurality of obstacles 30 located in the space 10.

Referring to FIGS. 1, 2, and 5, the robot control device 100 may receive destination information and a local coordinate of the robot 200 from the robot 200 through the communication network 300 (S210 and S220).

Here, in the step of receiving the local coordinate of the robot 200 (S220), the robot 200 may receive the local coordinate from a location coordinate system and transmit the received local coordinate to the robot control device 100, or the local coordinate system may sense the robot 200 located in the cell coverage of the local coordinate system to transmit the local coordinate to the robot control device 100.

The robot control device 100 may find the current location of the robot 200 from the received local coordinate of the robot 200 based on the spatial map (S230).

For example, the robot 200 may transmit the local coordinate of the robot 200 as well as specific information of the first location coordinate system A, i.e., ID information to the robot control device 100. The robot control device 100 may determine the approximate location of the robot 200 based on the transmitted ID information of the first location coordinate system A and detailed location of the robot 200 based on the transmitted local coordinate.

Further, the robot control device 100 may determine the found current location of the robot 200 and the transmitted destination information using the spatial map and calculate a shortest traveling path of the robot 200 based on a determined result (S240).

Here, the robot control device 100 may estimate a plurality of traveling paths that may avoid a plurality of obstacles 30 mapped to the spatial map, that is, a plurality of traveling paths from the current location of the robot 200 to the destination.

Subsequently, the travelling distance of each of the estimated travelling paths may be calculated and, among the travelling paths, one travelling path having the shortest distance may be selected as the optimal travelling path of the robot 200.

Further, the robot control device 100 may generate a control signal according to the selected optimal travelling path and transmit the generated control signal to the robot 200 through the communication network 300.

The driving controller 240 of the robot 200 may control the driving unit of the robot 200 in response to the control signal transmitted from the robot control device 100 to travel to a desired destination in the space 10 by the shortest distance (S250).

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims. Accordingly, the actual technical protection scope of the present invention must be determined by the spirit of the appended claims.

What is claimed is:

1. A method of generating a map using a freely travelling robot, comprising:
calculating a global coordinate of the robot based on a local coordinate of the robot that is outputted from each of a plurality of location coordinate systems arranged in a space; and
estimating a location of each of the plurality of location coordinate systems in the space based on the calculated global coordinate of the robot to generate a spatial map based on the estimated location of each of the plurality of location coordinate systems.

2. The method of claim 1, wherein each of the plurality of location coordinate systems includes cell coverage,
wherein the calculating the global coordinate of the robot includes:
receiving the local coordinate of the robot outputted from one location coordinate system when the robot is located in the cell coverage of the one location coordinate system among the plurality of location coordinate systems.

3. The method of claim 2, wherein the local coordinate of the robot is a coordinate representing a relative location of the robot with respect to the one location coordinate system.

4. The method of claim 1, wherein the calculating the global coordinate of the robot comprising:
defining one location coordinate system outputting an initial local coordinate of the robot among the plurality of location coordinate systems as a central point of the space; and
calculating the global coordinate of the robot at the central point based on the local coordinate of the robot outputted from the one location coordinate system.

5. The method of claim 1, further comprising,
sensing each of a plurality of obstacles located in the space by the robot, and outputting obstacle information based on a sensed result to generate the spatial map.

6. The method of claim 5, wherein the spatial map is generated by:
estimating a location of each of the plurality of obstacles in the space based on the obstacle information; and
updating the spatial map based on the estimated location of each of the plurality of obstacles.

7. The method of claim 5, wherein the spatial map generated by calculating a global coordinate of the obstacle in the space based on the local coordinate of the robot outputted from a spot where the robot senses each of the plurality of obstacles from the plurality of location coordinate systems.

8. The method of claim 1, further comprising:
sensing the number of rotations of the motor of the robot to generate an offset based on a sensed the number of rotations of the motor; and
correcting an error in calculating the global coordinate of the robot using the offset.

9. A method of calculating an optimal travelling path of a freely travelling robot, comprising:
receiving destination information from the robot;
receiving a local coordinate of the robot outputted from one location coordinate system among a plurality of location coordinate systems located in a space; and
finding a current location of the robot from the local coordinate of the robot based on a spatial map to calculate a shortest travelling distance from the current location to a destination based on the destination information.

10. The method of claim 9, wherein the receiving the local coordinate of the robot comprising,
receiving ID information of the one location coordinate system as well as the local coordinate of the robot calculated with respect to the one location coordinate system.

11. The method of claim 9, wherein the shortest travelling distance is generated by:
estimating a plurality of travelling paths from the current location of the robot to the destination; and
calculating a travelling distance of each of the estimated plurality of travelling paths to select one travelling path having the shortest distance among calculated travelling distances as the optimal travelling path.

12. The method of claim 11, wherein the spatial map includes a location coordinate of each of a plurality of obstacles,
wherein the calculating the plurality of travelling paths includes avoiding each of the plurality of obstacles based on the spatial map.

13. A robot control device comprising:
a spatial map generating unit that generates a spatial map based on a global coordinate of a robot calculated from a local coordinate of the robot in a space; and
a travelling path calculating unit that calculates and outputs an optimal travelling path to a destination corresponding to destination information transmitted from the robot based on the spatial map.

14. The robot control device of claim 13, wherein the spatial map generating unit includes a coordinate system mapping unit that estimates a location of each of a plurality of location coordinate systems arranged in the space from the global coordinate of the robot and maps the estimated location to the spatial map.

15. The robot control device of claim 13, wherein the spatial map generating unit includes an obstacle mapping unit that estimates a location of each of a plurality of obstacles located in the space from obstacle information of each of the plurality of obstacles sensed by the robot and, maps the estimated location to the spatial map.

16. The robot control device of claim 13, wherein the travelling path calculating unit calculates and outputs the shortest travelling distance from a current location of the robot to a destination based on destination information transmitted from the robot.

17. The robot control device of claim 13, wherein the travelling path calculating unit estimates a plurality of travelling paths from a current location of the robot to a destination based on destination information transmitted from the robot and selects and outputs one travelling path having a shortest distance among the estimated plurality of travelling paths.

18. The robot control device of claim 13, wherein the robot includes:
a global coordinate calculating unit that calculates the global coordinate of the robot from the local coordinate of the robot outputted from each of a plurality of location coordinate systems arranged in the space, and
an error correcting unit that senses the number of rotations of a motor of the robot to generate an offset and corrects an error occurring when the global coordinate calculating unit calculates the global coordinate of the robot using the offset.
